(19) United States
(12) Patent Application Publication
(10) Pub. No.: US 2015/0198490 A1
(43) Pub. Date: Jul. 16, 2015

(54) METHODS OF CHARACTERIZING PROCESSED OPTICAL FIBER ENDS USING SECOND-HARMONIC GENERATION

(71) Applicant: Corning Cable Systems LLC, Hickory, NC (US)

(72) Inventors: Minghan Chen, Painted Post, NY (US); Ming-Jun Li, Horseheads, NY (US); Anping Liu, Horseheads, NY (US)

(73) Assignee: Corning Cable Systems LLC, Hickory, NC (US)

(21) Appl. No.: 14/156,799

(22) Filed: Jan. 16, 2014

(51) Int. Cl. G01L 1/24

(52) U.S. Cl. CPC G01L 1/242

(57) ABSTRACT

A method of characterizing processed optical fiber ends using second-harmonic generation (SHG) is disclosed. The method includes sequentially irradiating micro-volumes within the end section with a focused laser beam of wavelength λ_{L}; sequentially detecting respective amounts the SHG light emitted from the respective micro-volumes; correlating the amounts of the detected SHG light with respective amounts of stress; and determining one or more optical properties of the end section of the optical fiber based on the amounts of stress. The optical fiber being measured can be held in a ferrule. The stress in the optical fiber end section can be due to processing the optical fiber end using laser and/or mechanical means.

### FIELD

The present disclosure relates to optical fibers held by ferrules, and in particular relates to methods of characterizing the processed ends of optical fibers that are held by ferrules by using second-harmonic generation.

The entire disclosure of any publication or patent document mentioned herein is incorporated by reference.

### BACKGROUND

Certain optical fiber applications call for optical fibers to be placed in optical communication by being joined together by optical connectors, which can be engaged and disengaged repeatedly. Optical connectors are used mostly at joints that need to be switched for optical service operation and maintenance reasons. One important step in making an optical connector involves terminating the optical fiber, which is held by a ferrule and which has an end that protrudes from an end face of the ferrule. The optical fiber end needs to be processed, e.g., cleaved and polished, so that the optical fiber end is flush or otherwise precisely positioned with respect to the ferrule end face. The ferrule is then added to an optical-connector assembly to constitute the optical connector.

Processing the optical fiber end involves cleaving, polishing, or both cleaving and polishing (typically cleaving is followed by polishing). The cleaving and polishing is usually accomplished using either a mechanical-based process, a laser-based process, or a combination thereof (e.g., laser cleaving followed by mechanical polishing). The cleaving and polishing process can significantly affect the amount of stress at the optical fiber end. The stress at the optical fiber end can adversely impact a number of important optical properties, including optical birefringence and polarization, as well as the coupling coefficient (i.e., the coupling efficiency) between optical fiber connectors. It is therefore important to have an effective means for measuring the stress of the end of the optical fiber after the optical fiber end has been processed. This measurement of stress needs to be taken not just at the fiber end facet but also within the volume adjacent the fiber end facet since the stress usually varies within the volume.

### SUMMARY

The methods disclosed herein and the system used to carry out the methods utilize techniques usually used to measure multiphoton fluorescence within micro-volumes (e.g., in the range from 10 femtoliters to 3,500 femtoliters) within the end section of a processed optical fiber held by a ferrule. Fluorescence microscopy is described in U.S. Pat. No. 5,034,613.

The methods disclosed herein make use of the fact that a stressless optical fiber has no second order non-linearity due to its center symmetry. As such, second harmonic generation (hereinafter, SHG) cannot be induced in the optical fiber by laser irradiation. However, several effects, including thermal, electrical or mechanical poling, can break this center symmetry, thereby inducing stress in the glass that makes up the optical fiber. This in turn allows for the emission of light by SHG when irradiated by a laser. Stress-induced second harmonic generation in silica glass is described in the article by Nasu et al., “Stress-induced second harmonic generation in silica glass,” Journal of the Ceramic Society of Japan, Vol. 116, No. 1359, November 2008, pp. 1232-1233.

The amount of SHG light emitted is substantially in proportion to the amount of induced stress. Thus, the SHG light can be used to characterize the stress profile of an end section (or “end’) of an optical fiber that has been processed, e.g., cleaved and polished. The characterization of the stress can in turn be used to characterize various optical properties of the end section of the optical fiber, which in turn can be used to estimate the performance (e.g., coupling efficiency, tolerance to misalignments, etc.) of the optical fiber as part of an optical fiber connector.

As noted above, SHG is induced by laser irradiation. Once the intensity of the laser beam reaches a certain level (i.e., an intensity threshold), the multiphoton response that creates fluorescence light grows exponentially. For an optical fiber residing in a ferrule, scanning a focused laser beam downward into its volume generates two-photon fluorescence in a micro-volume of the glass. The laser irradiation will also generate SHG light representative of the amount of stress present in the micro-volume. The back-scattered fluorescence light and the SHG light is collected and processed. This processing can include generating a representation (e.g., profile, image, map, etc.) of the stress within the optical fiber at the fiber end. Alternatively, the fluorescence light is substantially filtered out so that substantially only the SHG signal is collected and processed. If there is no stress in the micro-volume of glass, then the collected light will constitute only two-photon fluorescence light.

An aspect of the disclosure is a method of measuring stress in an end section of an optical fiber, wherein the end section has an end facet. The method includes: focusing pulsed laser light of a first wavelength λ_{L} through the end facet for one or more locations within the end section to define corresponding one or more micro-volumes, the focused laser light causing the emission of SHG light of a second wavelength λ_{H}=(0.5)·λ_{L} from the one or more micro-volumes in proportion to an amount of stress present in the micro-volume; detecting an intensity of the emitted SHG light for each of the micro-volumes; and correlating the measured intensity of the emitted SHG light to an amount of stress for each of the one or more locations within the end section.

Another aspect of the disclosure is a method of characterizing stress in an end section of an optical fiber held by a ferrule. The method includes: sequentially irradiating micro-volumes within the end section with a focused laser beam of wavelength λ_{L}; sequentially detecting respective amounts of SHG light of wavelength=(0.5)·λ_{L} emitted from the respective micro-volumes due to said sequential irradiation; correlating (e.g., comparing, associating, relating, etc.) the amounts of the detected SHG light with respective amounts of stress; and determining one or more optical properties of the end section of the optical fiber based on the amounts of stress.

Another aspect of the disclosure is a method of characterizing stress in an end section of an optical fiber held by a ferrule. The method includes processing the end section of the optical fiber in a manner that induces stress into at least a portion of an end section of the optical fiber; sequentially irradiating micro-volumes within the end section of the optical fiber with a focused laser beam of wavelength λ_{L} to cause second-harmonic-generation (SHG) light to be emitted from the micro-volumes; detecting respective amounts of the SHG light of wavelength λ_{H}=(0.5)·λ_{L} emitted from the respective micro-volumes; and correlating (e.g., comparing, associating, relating, etc.) the amounts of the detected SHG light with respective amounts of stress. In an example, the processing of the end section of the optical fiber includes at least one of a cleaving process and a polishing process. In an example, either of the cleaving and polishing processes can be mechanical-based or laser-based.

These and other aspects of the disclosure will be further understood and appreciated by those skilled in the art by reference to the following specification, claims and appended drawings.

### BRIEF DESCRIPTION OF THE DRAWINGS

A more complete understanding of the present disclosure can be had by reference to the following Detailed Description when taken in conjunction with the accompanying drawings, where:

FIG. 1A is an isometric view of an example an optical fiber being inserted into a central bore of a ferrule, with a close-up inset of the optical fiber showing a core and cladding of the optical fiber;

FIG. 1B is similar to FIG. 1A, but shows the optical fiber held within the ferrule central bore, wherein a spare section of the optical fiber extends beyond a front end of the ferrule;

FIG. 1C is similar to FIG. 1B, but shows a laser beam irradiating the spare section of optical fiber at the ferrule front end to laser process the optical fiber;

FIG. 1D is similar to FIG. 1C, but shows an end facet of the optical fiber that substantially coincides with the ferrule front end as a result of the laser processing;

FIG. 2 is a close-up cross-sectional view of the front end of the ferrule and the corresponding end facet, end section, and corresponding volume of the laser processed (e.g., cleaved and polished) optical fiber;

FIG. 3A is schematic diagram of an example embodiment of a fluorescence microscopy system suitable for carrying out methods of characterizing processed optical fiber ends according to the present disclosure;

FIG. 3B is a close-up view of an objective lens of the fluorescence microscopy system of FIG. 3A along with the ferrule and optical fiber as operably arranged in an optical fiber connector supported by a movable stage, with the figure illustrating an exemplary method of aligning the focused laser beam with the optical fiber;

FIG. 4 is a close-up, cut-away, perspective view of the end section of the processed optical fiber showing how measurements can be made along different lines L1, L2 extending into the optical fiber core and cladding at different surface locations SL(x₁, y₁) and SL(x₂,y₂), with the close-up inset showing exemplary micro-volumes and the fluorescent and SHG light emitted therefrom;

FIGS. 5A and 5B are plots of the intensity spectra I(λ) (normalized units) versus λ (nm) for two different single-mode fibers mechanically cleaved and polished as part of the process of forming respective single-mode optical fiber connectors, wherein the plots show the SHG signal associated with emitted SHG light from the optical fiber at the measured location within the optical fiber end section;

FIGS. 6A and 6B are plots of the intensity spectra I(λ) (normalized units) versus λ (nm) similar to FIGS. 5A and 5B for two different optical fibers in an optical fiber ribbon, wherein the two optical fibers were laser cleaved and polished, with the figures illustrating a relatively strong SHG signal as compared to the processed optical fibers of FIGS. 5A and 5B;

FIG. 7 is a plot of axial stress σ_{z} (MPa) vs. radius r (μm) based on published measurements taken on an example SMF-28 single-mode optical fiber; and

FIGS. 8A through 8C are plots of the intensity spectra I(λ) (normalized units) versus λ(nm) taken at the center (FIG. 8A), middle (FIG. 8B) and edges (FIG. 8C) of an example optical fiber, showing SHG signals that generally match the axial stress profile of FIG. 7A.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

In some of the Figures, Cartesian coordinates are provided for the sake of reference and are not intended as limiting with respect to specific directions and orientations of the systems and methods described herein.

The claims as set forth below are incorporated into and constitute part of this detailed description.

In the discussion below, the terms optical fiber “end” and optical fiber “end section” are synonymous and used interchangeably. The end face of the optical fiber end or end section is referred to as the “end facet.”

### Processing the End Section of the Optical Fiber

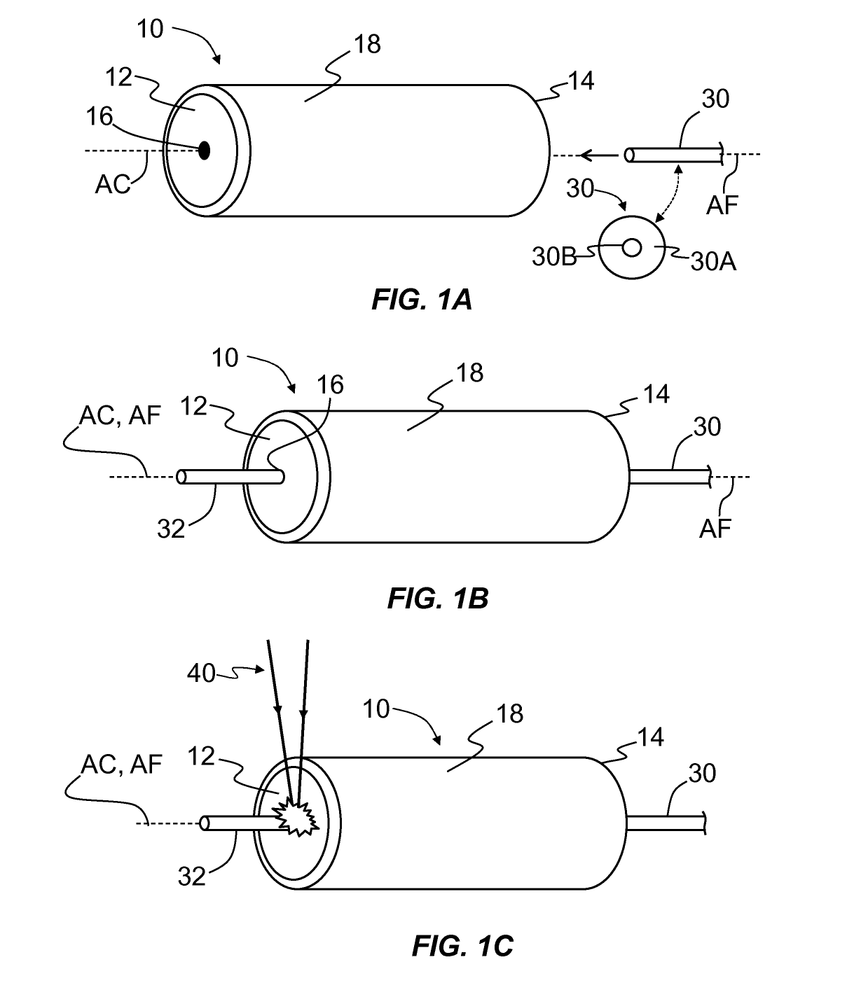

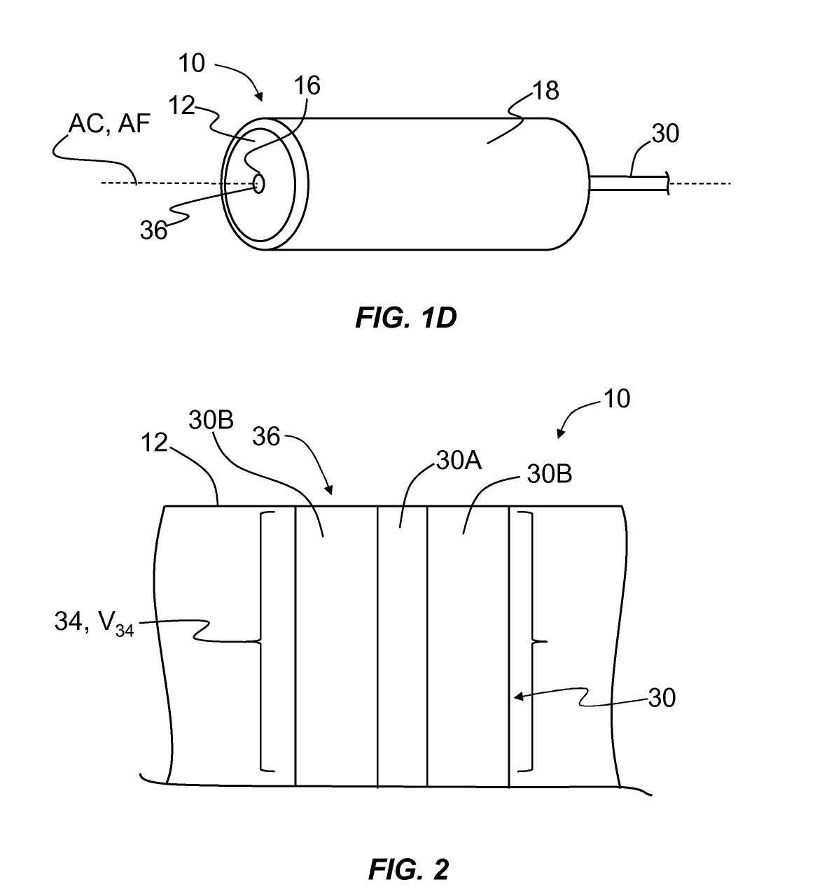

FIG. 1A is an isometric view of an example ferrule 10 that is used as part of an optical fiber connector assembly to form an optical fiber connector. Ferrule 10 has a front end 12, a rear end 14, and a central bore 16 that runs generally along a central axis AC of the ferrule. Central bore 16 is open at the front and back ends. Ferrule 10 also includes an outer surface 18. Central bore 16 is sized to accommodate an optical fiber 30 as well as a thin layer of bonding material, e.g., epoxy (not shown), to secure the optical fiber to the ferrule. The close-up inset of FIG. 1A is a cross-sectional view of optical fiber 30 and shows a core 30A surrounded by a cladding 30B. An example ferrule 10 has a diameter of nominally 2.2 mm, while an example optical fiber 30 has a diameter of nominally 125 μm. An example radius of core 30A is nominally 9 μm. An example ferrule central bore 16 has a nominal diameter of 126 μm to accommodate the aforementioned bonding material. Other ferrule sizes and fiber sizes are also possible. While the methods disclosed herein are described in connection with single-mode optical fibers, the methods can also be used on other types of optical fibers, such as multimode optical fibers, that are subjected to processing that induces stress.

FIG. 1B is similar to FIG. 1A and shows ferrule 10 with optical fiber 30 disposed in central bore 16, with a spare section 32 of the optical fiber extending beyond ferrule front end 12. Optical fiber 30 has a central axis AF that is substantially coaxial with ferrule central axis AF when the optical fiber resides within central bore 16. The spare section 32 of optical fiber 30 needs to be processed to create a smooth optical fiber end that is substantially flush with (i.e., within 15 or even 10 microns of) ferrule front end 12.

FIG. 1C is similar to FIG. 1B and shows optical fiber 30 being processed by a laser beam 40. Laser beam 40 is shown irradiating optical fiber section 32 at front end 12 of ferrule 10. An example laser beam 40 is generated by a CO₂ laser operating a nominal wavelength of 10.64 μm. Other types of lasers and operating wavelengths can be used to generate laser beam 40. Laser beam 40 is directed such that the spare optical fiber section 32 is cleaved from the main part of optical fiber 30 at ferrule front end 12. The result is the formation of an end facet 36 of optical fiber 30 that is substantially coincident with the ferrule front end 12, as shown in FIG. 1D. The laser beam 40 can be used to both cleave and polish end facet 36, wherein the polishing occurs due to the re-flow of the molten silica at the fiber end. Alternatively, mechanical polishing can be used to polish the fiber end to form end facet 36 after laser cleaving. In another example, the cleaving process is also mechanical.

FIG. 2 is a close-up cross-sectional view of a portion of ferrule 10 at ferrule front end 12. The optical fiber 30 includes an end or end section 34 terminated by end facet 36. End section 34 defines a volume V₃₄ that includes core 30A and cladding 30B. When optical fiber 30 is processed to remove spare optical fiber section 32, stress can build up in the resultant end section 34. The stress in end section 34 can impact the optical properties of optical fiber 30, as noted above. Thus, the methods disclosed herein include measuring and characterizing the stress in end section 34 at various locations within volume V₃₄. In an example, characterizing the stress includes measuring the stress at a plurality of locations to generate a 1D, 2D, or 3D stress profile or map.

### Measurement System

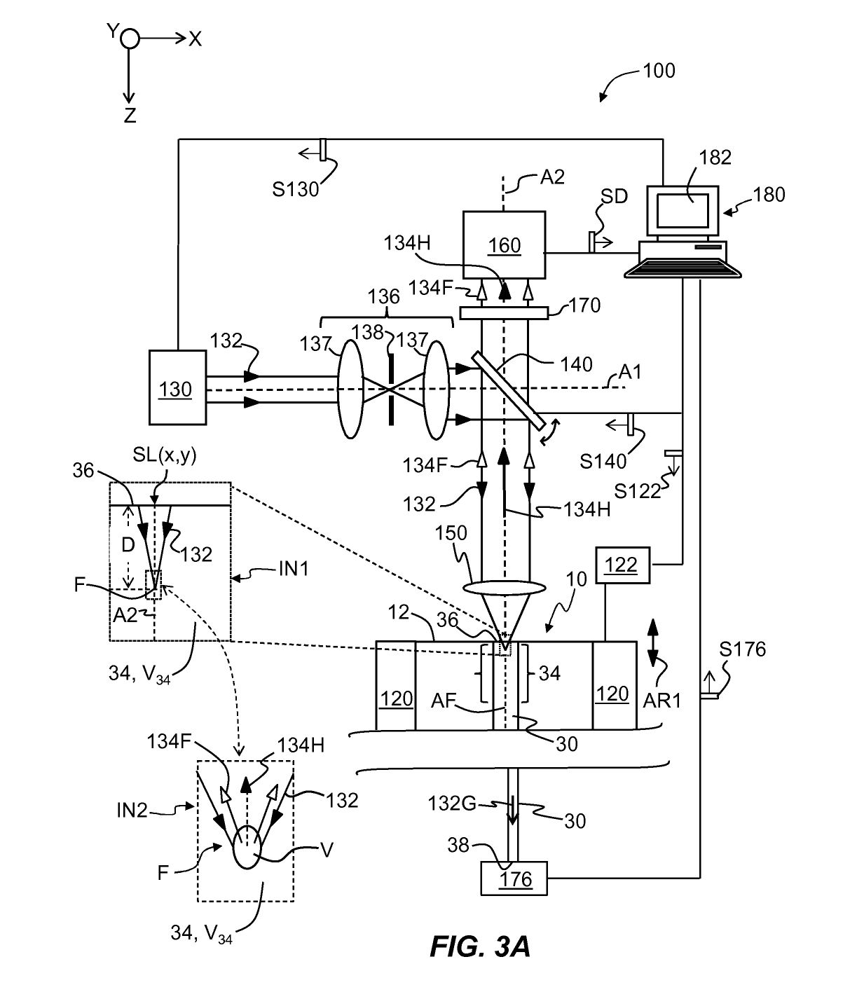

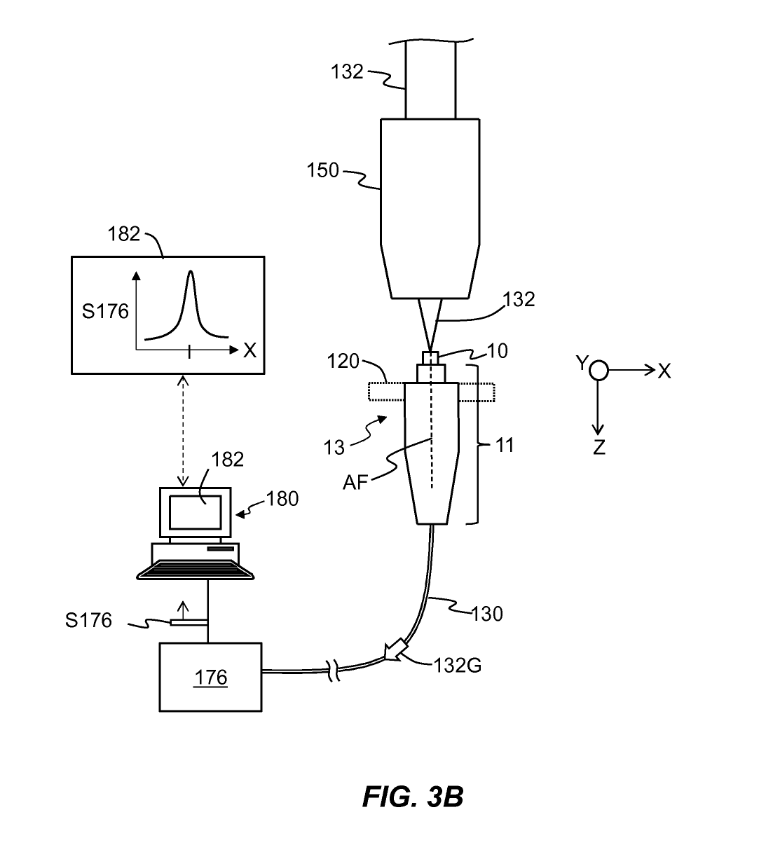

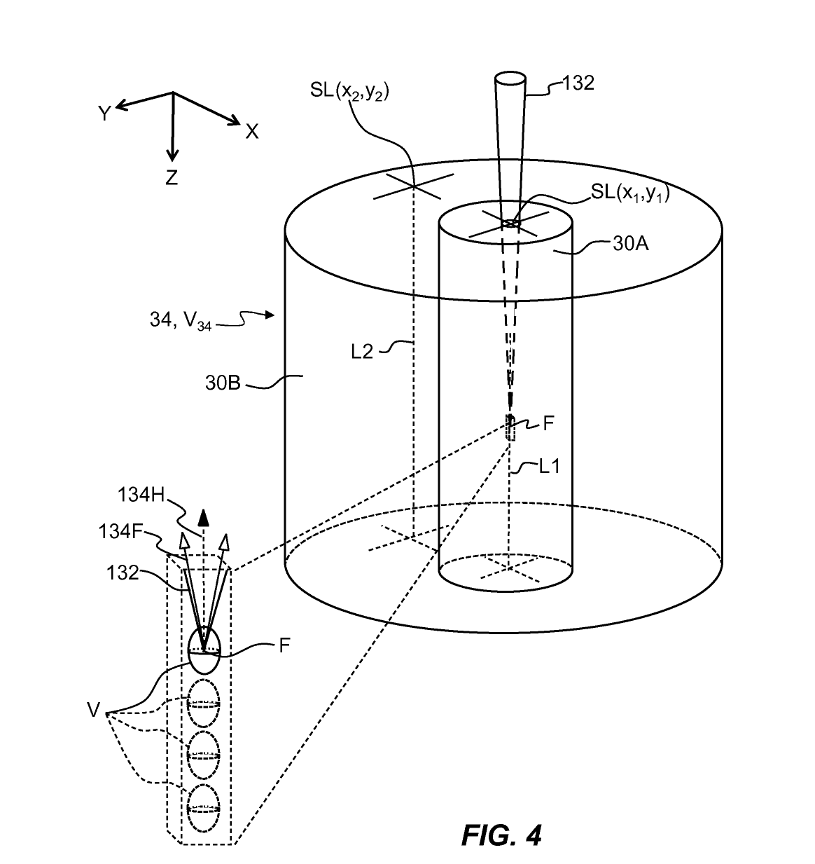

FIG. 3A is schematic diagram of an example embodiment of a fluorescence microscopy system 100 suitable for use as a measurement system for carrying out the SHG-based methods of characterizing processed optical fiber ends according to the present disclosure. The system 100 includes a movable stage 120 configured to operably support ferrule 10 and optical fiber 30 held therein. The moveable stage 120 is operably connected to a stage driver 122 that directs the motion of the movable stage in response to a stage control signal 5122. In an example, movable stage 120 can move ferrule 10 in X-, Y- and Z-directions so that measurements can be taken at different surface locations SL(x,y), as shown in the first close-up inset IN1. That is to say, stress measurements can be obtained at different depths D beneath respective surface locations SL(x,y), as described in greater detail in connection with FIG. 4, introduced and discussed below. Motion in the Z-direction is indicated by a double-ended arrow AR1. Movable stage 120 can also move ferrule 10 and fiber 20 into an aligned position to obtain accurate positioning for the surface locations SL(x,y), as discussed in greater detail below

With continuing reference to FIG. 3A, system 100 includes, in order along a first optical axis A1, a laser 130 and a spatial-filter optical system 136. The laser 130 emits laser light 132, as schematically represented by the solid black arrowheads. The laser light 132 has a wavelength λ_{L}. The laser 130 is configured to provide laser beam 132 with sufficient power to generate SHG light as described below. The laser light 132 constitutes a laser beam that at times is collimated, divergent, or convergent as it travels over its optical path from laser 130 to end section 34 of optical fiber 30. The laser beam 132 includes a focus F (see first close-up inset IN1) as defined and discussed in greater detail below. The terms “laser light” and “laser beam” are used interchangeable herein and one skilled in the art will understand how these terms are used in different contexts. In an example, laser 130 emits pulses so that laser beam 132 is a pulsed laser beam. An example laser 130 is a femtosecond laser that has an operating wavelength of nominally 1.06 μm and operating pulse durations ranging from 1 fs to 1000 fs.

The spatial-filter optical system 136 is configured to receive laser light 132 and spatially filter and collimate this light to remove high-frequency components that adversely affect the uniformity of laser beam 132. In an example, spatial-filter optical system 136 includes two positive lenses 137 with a pinhole aperture 138 arranged at their common focus (which defines the location of a Fourier plane) and serving as a high-frequency filter.

The system 100 also includes a second optical axis A2 that intersects first optical axis A1 at nominally a right angle. A beam splitter 140 is disposed at the intersection of first and second optical axes A1 and A2. The beam splitter 140 can be, for example, a fixed dichroic mirror or a scanning dichroic mirror. When beam splitter 140 comprises a fixed dichroic mirror, the laser beam focus F moves only in the Z-direction and thus provides only stress information associated with a single surface location SL(x,y), i.e., provides a single column of data that corresponds to a single column of micro-volumes V (as introduced and discussed below; see FIG. 4) within the larger volume V₃₄ of end section 34 of optical fiber 30. This simple approach may be adequate for fast online monitoring for certain applications and situations. However, it may not provide the most accurate stress profile or the highest resolution capability. With the size of laser beam 132 being typically only several microns in diameter at focus F, any tiny defect within volume V34 of end section 34 may lead to a false signal indicating the presence of stress where in fact none exists.

This issue can be overcome by replacing a stationary (i.e., non-adjustable) beam splitter 140 with an adjustable (e.g., scanning) beam splitter, such as a scanning dichroic mirror. With a scanning beam splitter 140, a larger number of measurements of end section 34 can be taken.

The system 100 also includes an objective lens 150, which is disposed along second optical axis A2 in the +Z-direction relative to beam splitter 140 and which resides near end facet 36 of optical fiber 30. A spectrometer 160 is arranged along second optical axis A2 in the −Z-direction relative to beam splitter 140. In an example, spectrometer 160 is highly sensitive, e.g., comprises a photomultiplier tube.

The system 100 also includes an optical filter (“filter”) 170 disposed along optical axis A2 in front of spectrometer 160. In an example, filter 170 is configured to pass (transmit) a fluorescent wavelength λ_{F} and a SHG wavelength λ_{H}, but block (e.g., reflect or absorb) the laser wavelength λ_{L} (with λ_{F}<λ_{L} and λ_{H}=(0.5)·λ_{L}). In an example, filter 170 has a relatively narrow bandwidth (bandpass) Δλ_{H} at the SHG wavelength λ_{H}, e.g., 5 nm≦Δλ_{H}≦50 nm, so that the filter passes substantially just the SHG light 134H of wavelength λ_{H} or SHG light 134H and a small portion of fluorescence light 134F around the SHG wavelength. In an example where filter 170 has a narrow bandpass centered on Δλ_{H}, spectrometer 160 can comprise a photodetector. In an example, filter 170 has a bandpass Δλ_{H} of 10 nm or less centered on the SHG wavelength λ_{H} to ensure that only the SHG light 134H (and any fluorescent light 134F within this band) reaches spectrometer 160. In an example where a relatively narrow bandpass Δλ_{H} is used (e.g., 50 nm or less), spectrometer 160 can be replaced with a sensitive photodetector to improve measurement throughput.

The spatial-filter optical system 136, beam splitter 140, and objective lens 150 constitute an example of a light-focusing optical system, while the objective lens, the beam splitter and filter 170 constitute an example of a light-receiving optical system. Other configurations of the light-focusing optical system and light-receiving optical system can be used, as will be appreciated by one skilled in the art, such as described in U.S. Patent Application Publication No. 2013/0221238.

In an example, the light-focusing optical system and the light-receiving optical system have at least one optical element in common and portions of their respective optical paths overlap.

System 100 also optionally includes a photodetector 176 that is optically coupled to an end 38 of optical fiber 30 opposite end facet 36.

The system 100 also includes a computer/controller 180 that is operably connected to stage driver 122, laser 130, beam splitter 140, spectrometer 160, and photodetector 176. In an example, computer/controller 180 includes a display 182. The computer/controller 180 is configured to store data, perform processing operations (e.g., calculations), and control the operation of system 100 in carrying out the methods described herein. In an example, computer/controller 180 includes data processing software embodied in a computer-readable medium, such as LabVIEW™ software or Matlab® software, that causes the computer/controller to process (e.g., analyze) and display SHG signal data as a function of location end section 34 of optical fiber 30. In an example, the data processing software in computer/controller 180 averages intensity measurement data of SHG signals taken at different surface locations SL(x,y) (e.g., SL(x₁,y₁), SL(x₂,y₂), SL(x₃,y₃), . . . , or SL(x₁,y₁), SL(x₂,y₁), SL(x₃,y₁), . . . , etc.).

The term “computer/controller” as the term is used herein is not limited to just those integrated circuits referred to in the art as computers, but broadly refers to computers, processors, microcontrollers, microcomputers, programmable logic controllers, workstations, application specific integrated circuits, and other programmable circuits (e.g., FPGAs), and their combinations.

FIG. 3B is a close-up view of objective lens 150 and ferrule 10. Ferrule 10 is shown held within a connector assembly 11 as part of an optical fiber connector 13. Thus, in an example, optical fiber connector 13 is movably supported by stage 120.

With continuing reference to FIG. 3A, in the operation of system 100, computer/controller 180, via a control signal 5130, causes laser 130 to generate pulsed laser light 132, which is spatially filtered and collimated by spatial-filtering optical system 136. The laser light 132 is then incident upon beam splitter 140, which directs the collimated laser light to travel along axis A2 in the +Z-direction. The direction of collimated laser light 132 can be adjusted by rotation of beam splitter 140 via a control signal 5140 from computer/controller 180. The collimated laser light 132 from beam splitter 140 is received by objective lens 150, which brings the light to focus F at a select distance D within end section 34 of optical fiber 30 as measured in the +Z-direction from end facet 36. The particular distance D (and in general, the (x,y,z) position of stage 120) is controlled by computer/controller 180 sending control signal 5122 to stage driver 122, which in turn places stage 120 in the appropriate location. The focus F is associated with a corresponding surface location SL(x,y), i.e., the two lie generally along optical axis A2.

With reference also to FIG. 3B, in an example embodiment focused laser beam 132 is first centered on (i.e., is aligned with) optical fiber axis AF to establish a reference position relative to optical fiber 30. At least a portion of focused laser beam 132 will enter optical fiber 30 at end facet 36 and travel down the length of the optical fiber as a guided wave 132G. The guided wave 132G exits optical fiber 30 at fiber end 38, where the light is detected by photodetector 176. Photodetector 176 generates in response a photodetector signal 5176, which is communicated to computer/controller 180. The focused laser beam 132 can be accurately aligned with the optical fiber axis AF by adjusting the surface location SL(x,y) of the focused laser beam 132 by adjusting stage 120 in response to photodetector signals 5176 until the amount of optical power detected by photodetector 176 (as represented by photodetector signal 5176) is a maximum. A plot of the amount of detected optical power as embodied in photodetector signal 5176 as a function of the X-position of optical fiber 30 is shown in the inset graph on display 182 in FIG. 3B.

Thus, in an example embodiment, alignment of focused laser beam 132 relative to optical fiber 30 can be achieved using feedback of laser light 132 coupled into and traveling in optical fiber 30 as guided wave 132G. Once such alignment is achieved, then stage 120 (which in an example is a precision stage) can be accurately and precisely moved to select surface locations SL(x,y) on optical fiber 30. Stage 120 can also accurately and precisely move to one or more select depths D in the z-direction for a given surface location SL(x,y). The close-up inset of the display 182 in FIG. 3B shows alignment in the X-direction by way of illustration. More generally, the alignment is carried out in the X- and Y-directions, and if necessary in the Z-direction.

With reference also to the close-up inset IN2 of FIG. 3A, the focused pulsed laser light 132 creates a multi-photon excitation with a small volume (hereinafter, micro-volume) V within the larger volume V₃₄ associated with end section 34 of optical fiber 30. This causes the emission of fluorescence light 134F (indicated by the white arrowheads) from micro-volume V, with the fluorescence light having the aforementioned fluorescent wavelength λ_{F}. The Z-position of focus F is varied sequentially along a line (i.e., in a select direction, such as the Z-direction) that extends into end section 34 from end facet 36. This serves to sequentially define micro-volumes V through end section 34 along the line (e.g., second optical axes A2) with a fixed (x,y) position corresponding to surface location SL(x,y). When there is stress present in the micro-volume V being irradiated by laser light 132, SHG light 134H will also be emitted.

FIG. 4 is a close-up cut-away perspective view of end section 34 and corresponding volume V₃₄ of optical fiber 30. FIG. 4 shows an example of how measurements can be made along different lines L1, L2 extending into the optical fiber core and cladding from end facet 36 from different surface respective locations SL(x₁, y₁) and SL(x₂,y₂). FIG. 4 also includes a close-up inset of an example of sequentially formed micro-volumes V. The micro-volumes V that are still to be formed are shown as dashed lines and lie on line L2 right below the solid-line micro-volume formed by focus F of focused laser light beam 132.

In an example, micro-volumes V have a size in the range from 10 femtoliters to 3,500 femtoliters. Also in an example, focused light 132 has a diameter in the range from 0.5 micron to 10 microns, which defines a diameter of micro-volume V. Also in an example, the relative locations of micro-volumes V relative to a reference location are determined to a resolution R in the range 0.5 micron≦R≦5 microns. Thus, the depth of a given measurement can be resolved to the resolution R. In other examples, the resolution R is less than 0.5 micron. The axial resolution R is defined by the 3D intensity distribution of focused light 132. The 3D intensity distribution is described in the z-direction by an axial point-spread function (PSF) and in the x-y directions by the conventional 2D PSF. The three-dimensional intensity distribution of laser light 132 at focus F includes a main high-intensity section centered at the focus and that has a generally ellipsoidal shape, with the long axis of the ellipsoid being along the illumination axis (see, e.g., Born and Wolf, “Principles of Optics,” Pergamon Press, N.Y, (3^{rd}. Ed.), Chapter 8.8.2). In an example, micro-volume V is defined by the aforementioned ellipsoidal section of the three-dimensional intensity distribution of laser light 132 at focus F.

To enhance SHG within volume V₃₄ of end section 34, of objective lens 150 is used to bring laser light beam 132 to the aforementioned focus F. The focus F serves to define a diameter of laser light beam 132. As a result, the fluorescent excitation and SHG is substantially restricted to the aforementioned micro-volume V, thereby resulting in a highly localized emission of fluorescence light 134F and SHG light 134H.

Continuing with additional reference to FIG. 3A, fluorescence light 134F and SHG light 134H emitted from micro-volume V of larger volume V₃₄ are collected by objective lens 150 and directed through beam splitter 140 and through filter 170 to spectrometer 160. In an example, filter 170 serves to pass fluorescence light 134F of wavelength λ_{F} and SHG light of wavelength λ_{H} since these wavelengths are shorter than the laser wavelength λ_{L}. Filter 170 thus serves in one embodiment as a short-pass filter that blocks laser light 132 from reaching spectrometer 160. As noted above, filter 170 can also be configured as a notch filter that passes substantially only SHG light 134H or SHG light and a small amount of fluorescence light 134F.

The fluorescence light 134F and the SHG light 134H that pass through filter 170 are detected by spectrometer 160, which converts the detected light into an electrical photodetector signal SD representative of the detected intensity spectrum (i.e., intensity vs. λ). The detected intensity spectrum is associated with one image voxel of volume V₃₄, with the voxel size corresponding to the size of micro-volume V. The computer/controller 180 receives electrical photodetector signal SD and in an example stores the spectral information embodied therein for further processing after all the fluorescence and SHG intensity data are collected for different locations within volume V₃₄ of end section 34. As noted above, in an example embodiment, spectrometer 160 can be a photodetector when the bandpass Δλ_{H} of filter 170 is sufficiently narrow.

The computer/controller 180 controls the operation of system 100 (e.g., via control signal 5122 provided to stage driver 122) so that stage 120 moves ferrule 10 and optical fiber 30 in the −Z-direction (i.e., upward toward objective lens 50). This allows for focus F to scan through volume V₃₄ in the +Z-direction in a sequential manner to sequentially form micro-volumes V along a line (see, e.g., FIG. 4) where each micro-volume generates amounts of fluorescence light 134F (i.e., a fluorescent signal) and SHG light 134H (i.e., an SHG signal) that will typically vary as a function of distance D into volume V₃₄. The collected fluorescence light 134F and SHG light 134H from each micro-volume V defines the aforementioned voxels, with each voxel having a corresponding intensity profile or spectrum. Thus, the intensity data includes an intensity spectrum I(λ) for a given voxel location (x,y,z).

The intensity data (i.e., the collection of voxels) is then used to form a representation of the SHG signals as a function of location within end section 34. Pixels can be formed from the voxels by collapsing the three-dimensional voxel in one or two dimensions. The resulting representation can be used to characterize the stress within end section 34 that arose due to the processing of the end section 34 of optical fiber 30. In an example, the measurements and subsequent characterization can be accomplished in a matter of seconds using system 100.

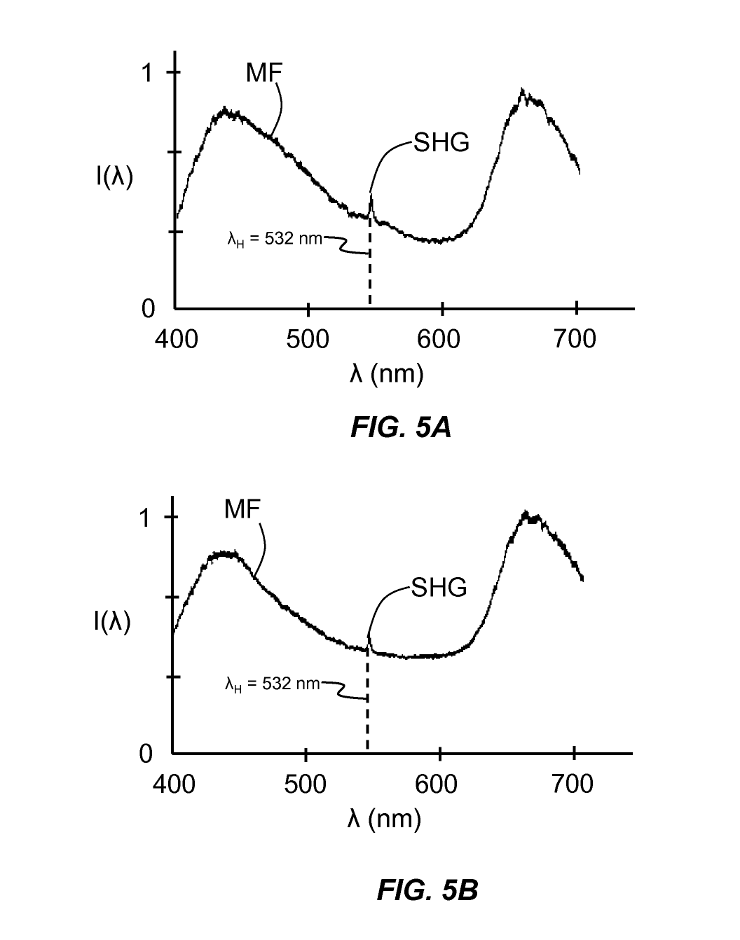

FIG. 5A and FIG. 5B are plots of intensity I (arbitrary units) versus wavelength λ (i.e., the intensity spectrum) as measured by system 100 at a single measurement location SL(x,y,z) for two example single optical fibers 30 held in respective commercially available ferrules 10 for single-mode optical connector. The optical fibers 30 were cleaved and polished using standard mechanical means known in the art. The measurement laser wavelength used was λ_{L}=1.06 μm=106 nm. The intensity spectrum I(λ) includes the general multi-fluorescence spectrum denoted MF that includes two broad peaks centered around 440 nm and 660 nm, as is expected for fused silica glass. The intensity spectrum also includes a relatively small SHG peak denoted SHG, which is located at 532 nm, i.e., at λ_{H}=(0.5)·λ_{L}. The existence of the SHG signal indicates the breaking of the center of symmetry of the glass caused by stress induced in optical fiber 30.

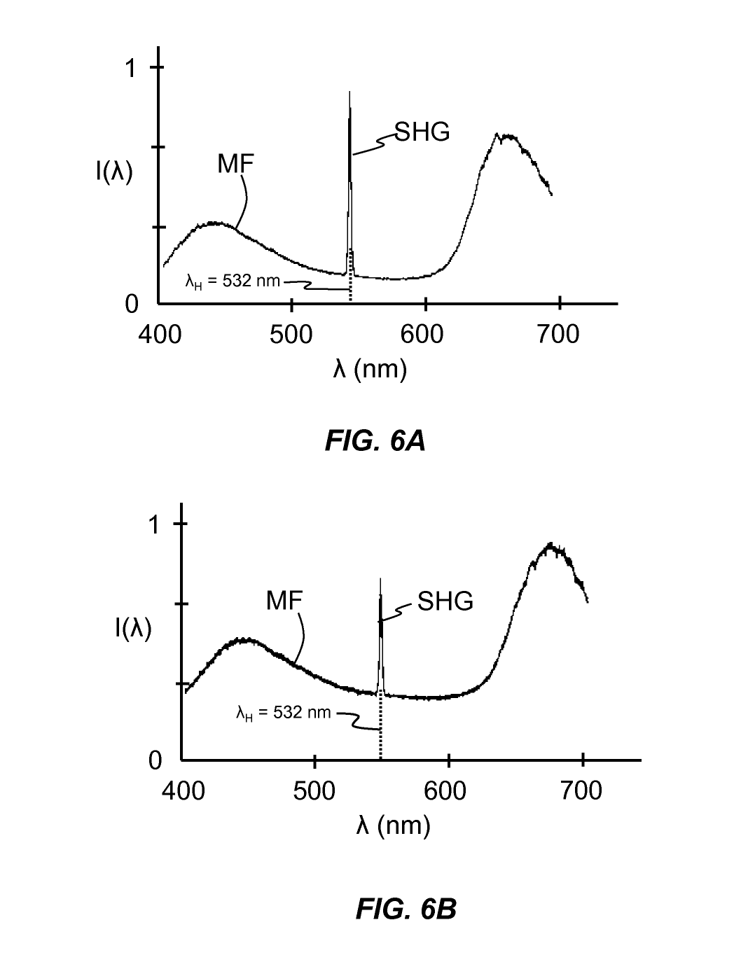

FIGS. 6A and 6B are plots of the intensity spectra I(X) similar to the plots of FIGS. 5A and 5B, but are for two fibers that are part of a fiber ribbon and that were cleaved using a CO₂ laser beam. Besides the multiphoton spectra MF with peaks around 440 and 660 nm associated with fused silica, a sharp SHG signal was observed. Comparing with the spectra of FIGS. 5A and 5B, a much higher SHG signal was observed for the fiber ribbon. This indicates that the laser-processed optical fibers in the fiber ribbon have greater stress than the mechanically processed optical fibers of the commercial optical connectors. It is believed that the rapid heating and cooling of the laser cleaving process acts to freeze the stress in the optical fiber glass before it has a chance to relax.

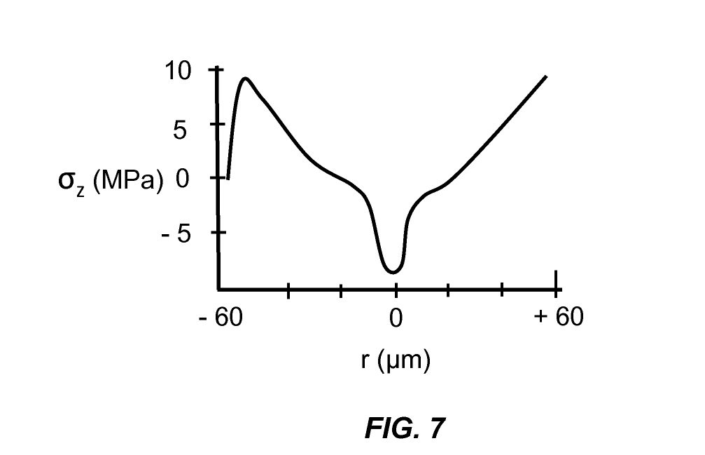

FIG. 7 is a plot of the measured axial stress σ_{z} (MPa) versus radius r (μm) as measured in a SMF-28 optical fiber 30 based on data set forth in FIG. 3A of the publication by Montarou et al., entitled “Residual stress profiles in optical fibers determined by the two-waveplate-compensator method,” Opt. Comm., 265, pp. 29-32 (2006). The plot shows the optical fiber has a negative (compressive) axial stress near the center of the fiber, i.e., around r=0 μm. The middle area of fiber at about r=+45 μm and r=−45 μm has an axial stress closer to zero, while at fiber edge, large amounts of positive (tensile) stress exist.

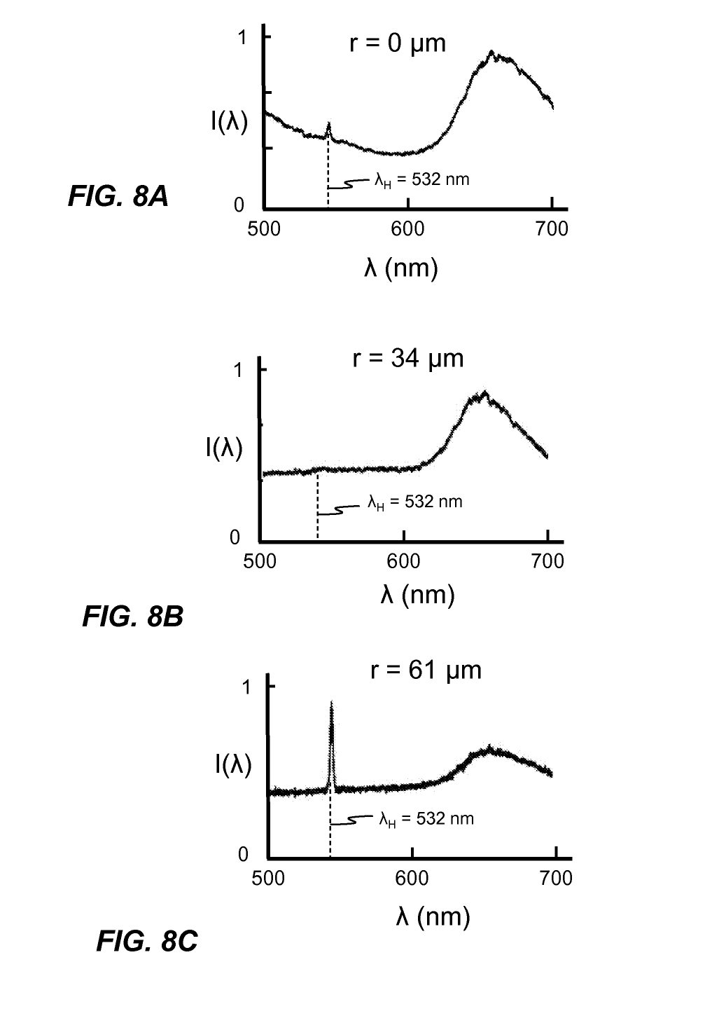

FIGS. 8A through 8C are plots of the intensity spectra I(X) similar to the plots of FIGS. 5A, 5B and 6A, 6B, as measured on a similar optical fiber 30 to that of FIG. 7. The measurements were made at the fiber center of r=0 (FIG. 8A), at a middle location of r=34 μm (FIG. 8B) and at an edge location r=61 μm (FIG. 8C). FIG. 8A shows that at the center of optical fiber 30, a small amount of SHG light (i.e., a small SHG signal) was observed at λ_{H}=532 nm. FIG. 8B shows that at the middle location of r=34 μm there is no SHG signal detected. FIG. 8C shows that at the edge location, a relatively large SHG signal was measured. The relative spectrum intensity ratio of SHG light 134H (at λ_{H}=532 nm) versus fluorescence light 134F at about λ_{F}=660 nm was 0.53, 0, and 1.44 for the areas at fiber center, middle, and edge respectively. This trend is consistent with the profile of the axial stress σ_{z} versus radius of the SMF-28 fiber as shown in FIG. 7.

In an example, measurements of the intensity spectra I(λ) are taken sequentially at multiple locations (i.e., micro-volumes V) within volume V₃₄ of end section 34. In example, the intensity spectra I(λ) are measured as close to end facet 36 as possible. In the case where filter 10 is a notch filter that passes a narrow band of wavelengths about the SHG wavelength of SHG light 134H, the intensity spectra I(λ) shows substantially only the SHG signal with a small region of the fluorescence spectrum to serve as the background intensity. In an example, intensity spectra I(λ) are measured along a diameter or a radius of optical fiber 30. In an example, the intensity spectra I(λ) are taken sequentially at different depths D for given location SL(x,y).

In an example, intensity spectra I(λ) are taken of a “standard” optical fiber (or a reference sample of the same material) having a measured amount of stress as a function of location so that the magnitude of the SHG signatures can be correlated (e.g., compared, associated, related, etc.) to the amount of stress present. This SHG-stress data can be included in computer/controller 180 (e.g., as a database of SHG intensities as a function of measured stress) to facilitate the conversion from measured SHG signals to a representation (e.g., plot, image, map, etc.) of the stress as a function of measurement locations (i.e., the (x,y,z) positions) within end section 34 of optical fiber 30. The representation of the stress can then be used to determine one or more optical properties of the end section 34 of the optical fiber so that the impact of the stress on connector performance can be evaluated. The measurements of the SHG signals 134H can be taken in both the core 30A and the cladding 30B of optical fiber 30. Even though the core and cladding 30A and 30B have different doping (i.e., the core is usually doped relative to a pure-silica cladding to give the core a varying index profile), the stress-induced SHG effects in the core and cladding are not substantially different.

The SHG-based methods disclosed herein for measuring and characterizing processed optical fiber ends are relatively quick, non-contact, and are non-destructive. The methods can be used to carry out realtime or near realtime monitoring of fiber connector stress during laser processing. The methods can also be used for quality control of connectorization processes to ensure that the stress in the optical fibers is well controlled. The methods can also be used to analyze stress differences amongst a variety of laser processes and to tune or optimize laser processes used on optical fibers.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of measuring stress in an end section of an optical fiber, wherein the end section has an end facet, comprising:
focusing pulsed laser light of a first wavelength λ_{L} through the end facet for one or more locations within the end section to define corresponding one or more micro-volumes, the focused laser light causing the emission of second-harmonic generation (SHG) light of a second wavelength λ_{H}=(0.5)·λ_{L} from the one or more micro-volumes in proportion to an amount of stress present in the micro-volume;
detecting an intensity of the emitted SHG light for each of the micro-volumes; and
correlating the measured intensity of the emitted SHG light to an amount of stress for each of the one or more locations within the end section.

2. The method according to claim 1, further comprising determining from the amount of stress at the one or more locations, at least one optical property.

3. The method according to claim 2, wherein the at least one optical property includes birefringence.

4. The method according to claim 1, wherein each micro-volume has a volume in the range from 10 femtoliters to 3,500 femtoliters.

5. The method according to claim 1, wherein the relative locations are determined to a resolution R in the range 0.5 micron≦R≦5 microns.

6. The method according to claim 1, further comprising forming the end section by holding the optical fiber in a ferrule having a front end, cleaving the optical at the ferrule front end to define the end facet, and then polishing the end facet.

7. The method according to claim 6, wherein at least one of the cleaving and polishing is performed using either a mechanical-based process or a laser-based process.

8. The method according to claim 1, further including passing the emitted SHG light through a filter that substantially blocks the laser light.

9. The method according to claim 1, wherein the focused laser light also causes the emission of fluorescence light, and wherein the filter passes the fluorescence light.

10. The method according to claim 9, wherein the filter has a transmission bandwidth between 5 nm and 50 nm centered on the SHG wavelength λ_{H}.

11. The method of claim 1, wherein said correlating including referring to a database of SHG intensities for measured amounts of stress.

12. A method of characterizing stress in an end section of an optical fiber held by a ferrule, the method comprising:
sequentially irradiating micro-volumes within the end section with a focused laser beam of wavelength λ_{L};
sequentially detecting respective amounts of second-harmonic-generation (SHG) light of wavelength=(0.5)·λ_{L} emitted from the respective micro-volumes due to said sequential irradiation;
correlating the amounts of the detected SHG light with respective amounts of stress; and
determining one or more optical properties of the end section of the optical fiber based on the amounts of stress.

13. The method according to claim 12, wherein the detection of the respective amounts of SHG light includes further includes:
passing the SHG light through a filter that blocks the laser beam wavelength λ_{L}; and
detecting the SHG light with either a photodetector or a spectrometer.

14. The method according to claim 12, wherein the ferrule is part of an optical fiber connector.

15. The method according to claim 12, wherein the detection of the respective amounts of SHG light includes further includes:
passing the SHG light through a filter having a bandpass Δλ_{H} centered on the SHG wavelength and wherein 5 nm≦Δλ_{H}≦50 nm; and
detecting the SHG light with either a photodetector or a spectrometer.

16. The method according to claim 12, wherein the detection of the respective amounts of SHG light includes further includes:
passing the SHG light through a filter having a bandpass Δλ_{H} centered on the SHG wavelength and wherein Δλ_{H}≦10 nm; and
detecting the SHG light with a photodetector.

17. A method of characterizing stress in an end section of an optical fiber held by a ferrule, comprising:
processing the end section of the optical fiber in a manner that induces stress into at least a portion of an end section of the optical fiber;
sequentially irradiating micro-volumes within the end section of the optical fiber with a focused laser beam of wavelength λ_{L} to cause second-harmonic-generation (SHG) light to be emitted from the micro-volumes;
detecting respective amounts of the SHG light wavelength λ_{H}=(0.5)·λ_{L} emitted from the respective micro-volumes; and
correlating the amounts of the detected SHG light with respective amounts of stress.

18. The method according to claim 17, further comprising determining one or more optical properties of the end section of the optical fiber based on the amounts of stress.

19. The method according to claim 17, wherein the process to which the end section of the fiber is subjected includes at least one of a cleaving process and a polishing process.

20. The method according to claim 17, wherein the process to which the end section of the fiber is subjected includes at least one of a laser process and a mechanical process.
